(19) United States
(12) Patent Application Publication
(10) Pub. No.: US 2011/0086559 A1
(43) Pub. Date: Apr. 14, 2011

(54) MOUNTING BASE FOR A TROLLING MOTOR FOOT PEDAL

(76) Inventor: Arlen Buffington, Mesa, AZ (US)

(21) Appl. No.: 12/578,822

(22) Filed: Oct. 14, 2009

(51) Int. Cl. B60L 15/20; B63H 21/17; B23K 31/02

(52) U.S. Cl. 440/7; 228/142

(57) ABSTRACT

A boat includes a boat deck having upper and lower deck portions and a deck transition portion. A mounting base is positioned so it extends proximate to the upper and lower deck portions and the deck transition portion. A foot operated trolling motor controller is carried by the mounting base and held at a desired orientation.

### BACKGROUND OF THE INVENTION

1. Field of the Invention

This invention relates generally to trolling motors for boats.

2. Description of the Related Art

Trolling motors are often used to control the movement of a boat, such as when fishing. A typical trolling motor includes a trolling motor controller, which can be hand or foot operated. A foot operated trolling motor controller includes a trolling motor foot pedal operatively coupled with the trolling motor through a control cable. In operation, more power is provided to the trolling motor in response to pushing down on the foot pedal, and less power is provided to the trolling motor in response to pushing down less on the foot pedal. In this way, the operation of the trolling motor is controlled using a foot operated trolling motor controller. Foot operated trolling motor controllers are convenient because they allow the operator to have both hands free for other tasks, such as fishing.

In some situations, the operator sits on a seat while fishing and controlling the operation of the trolling motor controller with his or her foot. It is often difficult, however, for the operator to operate the trolling motor controller with his or her foot from a seated position. One reason it is difficult to operate the trolling motor controller from a seated position is because the foot pedal is often laid flat on a deck of the boat, which makes it difficult to press down on it. The operator can move forward in the seat to adjust the angle between the foot pedal and his or her foot, but this is often inconvenient, especially when fishing. Hence, it is desirable to provide a foot operated trolling motor controller that is easier to operate from a seated position.

### BRIEF SUMMARY OF THE INVENTION

The present invention provides a boat, which includes a boat deck having upper and lower deck portions and a deck transition portion, and a mounting base positioned so it extends proximate to the upper and lower deck portions and the deck transition portion. In some embodiments, the mounting base is attached to the boat deck in a repeatably removeable manner. In this embodiment, the boat includes a mechanical fastening device which fastens the mounting base to the boat deck.

The boat includes a foot operated trolling motor controller carried by the mounting base. The mounting base holds the foot operated trolling motor controller at a desired angle to make it easier to operate. In some embodiments, the mounting base includes downwardly extending welded edges. In some embodiments, the upper surface of the mounting base is oriented at a non-zero angle relative to the lower deck portion. The mounting base can include downwardly extending front and back sidewalls welded to downwardly extending opposed sidewalls. In some embodiments, the mounting base includes a bend which extends around the outer periphery of its upper surface.

The present invention provides a boat, which includes a boat deck and a mounting base with a lower surface shaped to extend along the boat deck, wherein the mounting base includes a downwardly extending welded edge. In some embodiments, the mounting base is fastened to the boat deck in a repeatably removeable manner. In some embodiments, the boat deck includes upper and lower deck portions. In some embodiments, the mounting base has a lower surface shaped to extend proximate to the upper and lower deck portions.

In this embodiment, the boat includes a foot operated trolling motor controller carried by the mounting base. In some embodiments, the mounting base includes a tapered opening sized and shaped to receive a portion of the boat deck. In some embodiments, the mounting base includes a opposed tapered openings sized and shaped to receive a portion of the boat deck. In some embodiments, the mounting base includes first and second angled edges, the first and second angled edges engaging the upper and lower deck portions, respectively. In some embodiments, the foot pedal is attached to the mounting base in a repeatably removeable manner. In some embodiments, the mounting base includes a bend which extends around the outer periphery of its upper surface.

The invention employs a method, which includes steps of providing a piece of rectangular flat stock material and removing the corners of the rectangular flat stock material to form first and second opposed arms and third and fourth opposed arms. The method includes bending the first and second opposed arms and third and fourth opposed arms downwardly to form an upper surface and welding the first opposed arm to the third and fourth arm. In some embodiments, the step of bending includes forming a bend which extends around the outer periphery of the upper surface. The method includes welding the second opposed arm to the third and fourth arm and shaping a lower surface of the third and fourth opposed arms to conform to the shape of a boat deck. In some embodiments, the deck includes upper and lower deck portions and a deck transition portion, wherein the lower edges of the third and fourth opposed arms extend proximate to the upper and lower deck portions and the deck transition portion. In some embodiments, the method includes positioning a foot operated trolling motor controller so it is carried by the upper surface.

These and other features, aspects, and advantages of the present invention will become better understood with reference to the following drawings and description.

### BRIEF DESCRIPTION OF THE DRAWINGS

FIGS. 1 and 2 are perspective views of a boat having a boat deck.

FIGS. 3a and 3b are side views of a mounting base carrying a foot operated trolling motor controller for use with the boat of FIGS. 1 and 2.

FIGS. 4 and 5 are side perspective views of one embodiment of the trolling motor controller carried by mounting base.

FIGS. 6 and 7 are back and front perspective views, respectively, of the trolling motor controller being carried by the mounting base.

FIGS. 8 and 9 are perspective views of the mounting base in folded and unfolded conditions, respectively.

FIG. 10 is a flow diagram of a method of forming a mounting base for a foot operated trolling motor.

FIG. 11 is a flow diagram of a method of installing a mounting base for a foot operated trolling motor controller.

FIGS. 12a and 12b are perspective views of another embodiment of a boat deck which includes a foot operated trolling motor controller channel.

### DETAILED DESCRIPTION OF THE INVENTION

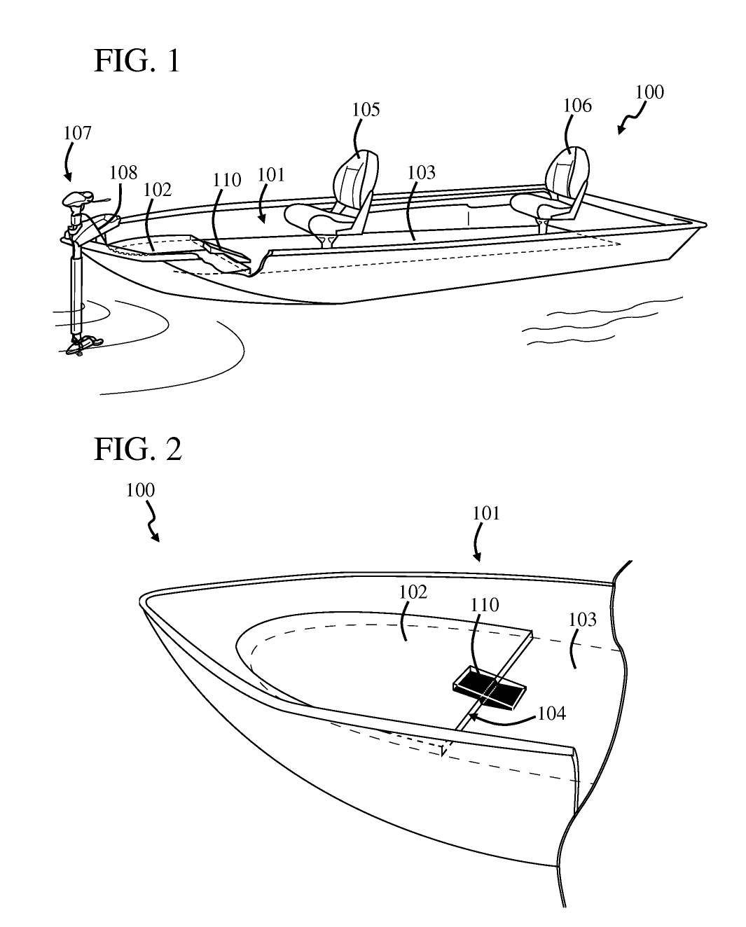

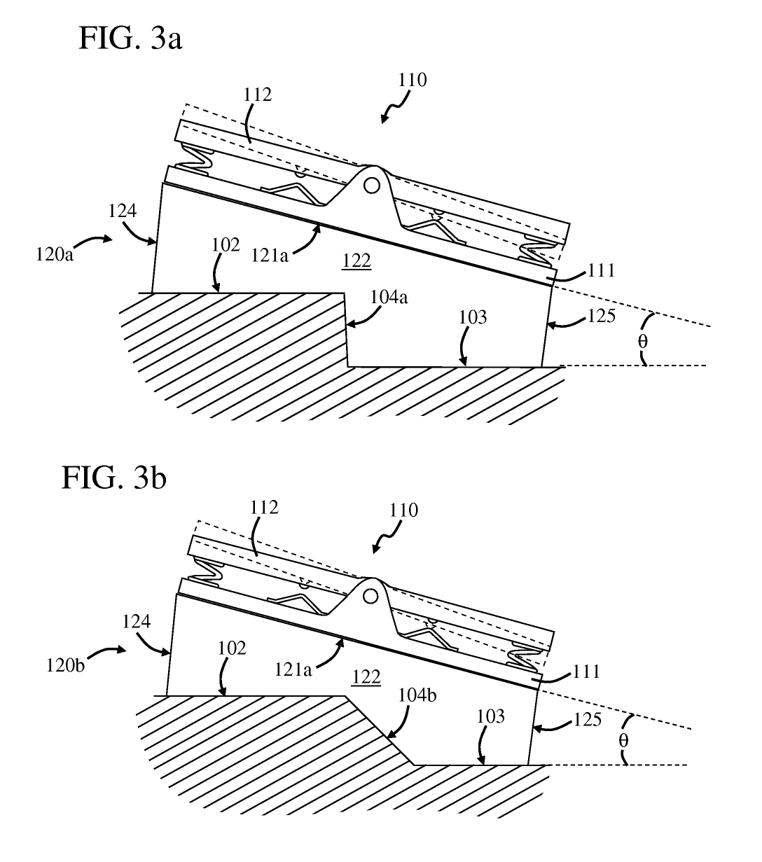

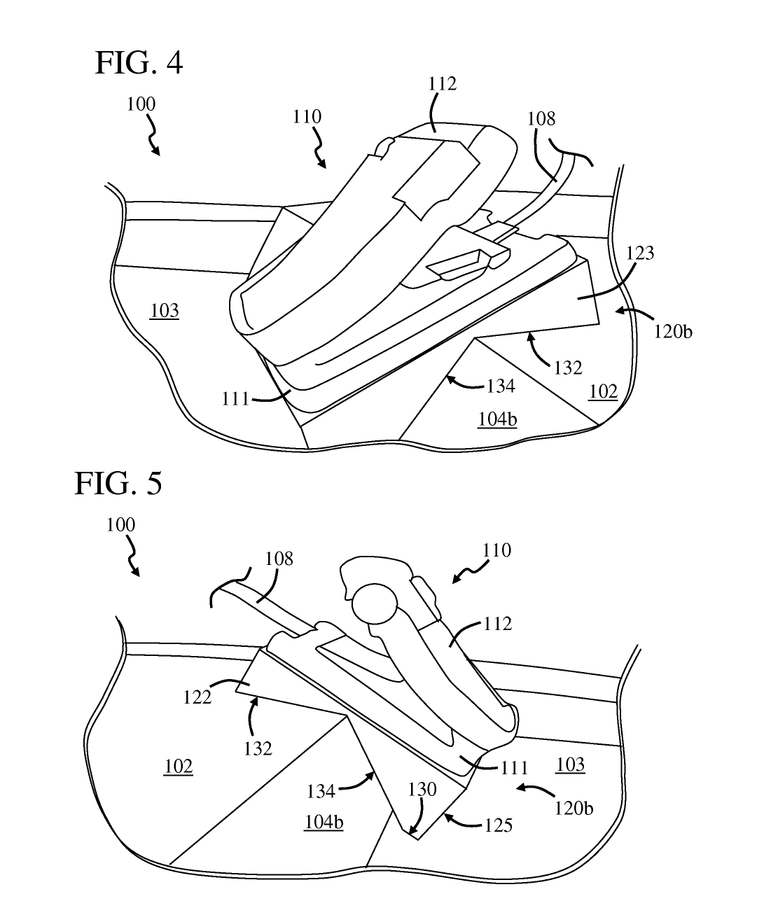

FIGS. 1 and 2 are perspective views of a boat 100 having a boat deck 101. Boat deck 101 includes upper and lower deck portions 102 and 103, and a deck transition portion 104 (FIG. 2). Deck transition portion 104 is shown as extending perpendicular to upper and lower deck portions 102 and 103 in FIGS. 2 and 3a. Deck transition portion 104 is stepped when it extends perpendicular to upper and lower deck portions 102 and 103. However, it should be noted that deck transition portion 104 can extend at an angle between upper and lower deck portions 102 and 103. One example in which deck transition portion 104 extends at an angle between upper and lower deck portions 102 and 103 is shown in FIGS. 3b, 4, 5, 6 and 7. Deck transition portion 104 is sloped when it extends at an angle between upper and lower deck portions 102 and 103.

In this embodiment, boat 100 includes front and back seats 105 and 106, which extend upwardly from lower deck portion 103. Boat 100 can be of many different types, such as those disclosed in U.S. Pat. Nos. 4,950,187 and 6,758,705, as well as U.S. Patent Application Nos. 2006001955, 20070232159 and 20080085641, the contents of all of which are incorporated herein by reference.

In this embodiment, boat 100 includes a trolling motor 107 which is used to control the movement of boat 100, such as when fishing. A foot operated trolling motor controller 110 is operatively coupled with trolling motor 107. Trolling motor controller 110 can be operatively coupled with trolling motor 107 in many different ways. In this embodiment, trolling motor controller 110 is operatively coupled with trolling motor 107 with a control cable 108 (FIGS. 1, 4 and 5).

Foot operated trolling motor controller 110 is generally operated by an operator while he or she is sitting on front seat 105. Hence, it is desirable to provide trolling motor controller 110 with a desired orientation so that it can be comfortably and easily and conveniently operated while the operator sits on front seat 105. Foot operated trolling motor controller 110 can be provided with a desired orientation in many different ways. In this embodiment, foot operated trolling motor controller 110 is provided with the desired orientation by positioning it on a mounting base. The mounting base can be of many different types. A mounting base 120a for a boat deck with a stepped deck transition portion 104a is shown in FIG. 3a, and a mounting base 120b for a boat deck with a sloped deck transition portion 104b is shown in FIG. 3b.

In this embodiment, mounting bases 120a and 120b are carried by boat deck 101 and positioned so that they extend proximate to upper and lower deck portions 102 and 103, as well as deck transition portions 104a and 104b, respectively. Mounting bases 120a and 120b are sized and shaped so that foot operated trolling motor controller 110 is held at an angle θ relative to lower deck portion 103. In this embodiment, foot operated trolling motor controller 110 is held at an angle θ relative to upper deck portion 102 because upper and lower deck portions are parallel with each other. As angle θ increases, foot operated trolling motor controller 110 is angled back towards seat 105, and as angle θ decreases, foot operated trolling motor controller 110 is angled away from seat 105. Angle θ is chosen so that the operator sitting in front seat 105 can easily and conveniently operate trolling motor controller 110.

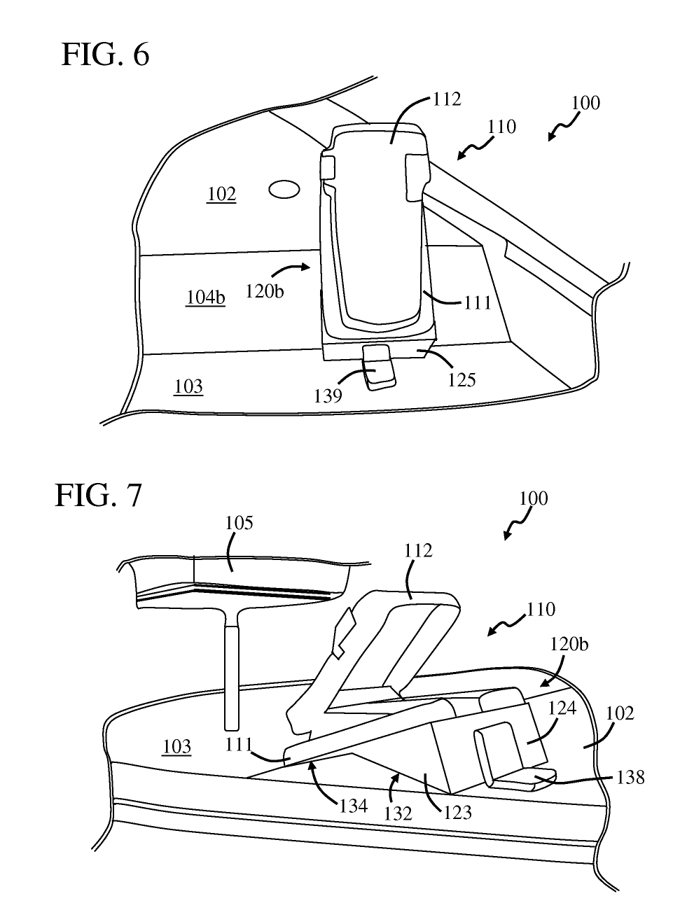

FIGS. 4 and 5 are side perspective views of one embodiment of trolling motor controller 110 carried by mounting base 120b. FIGS. 6 and 7 are back and front perspective views, respectively, of trolling motor controller 110 being carried by mounting base 120b. It should be noted that trolling motor controller 110 can be carried by mounting base 120a, if desired.

In this embodiment, trolling motor controller 110 includes a foot pedal base 111 and trolling motor foot pedal 112, wherein trolling motor controller 110 is operatively coupled with trolling motor 107 with control cable 108. In operation, more power is applied to trolling motor 107 in response to pushing down on trolling motor foot pedal 112, and less power is applied to trolling motor 107 in response to pushing down less on trolling motor foot pedal 112. In this way, the operation of trolling motor 107 is controlled using trolling motor controller 110. It should be noted that trolling motor foot pedal 112 is typically pushed down by the operator using his or her foot while sitting on front seat 105.

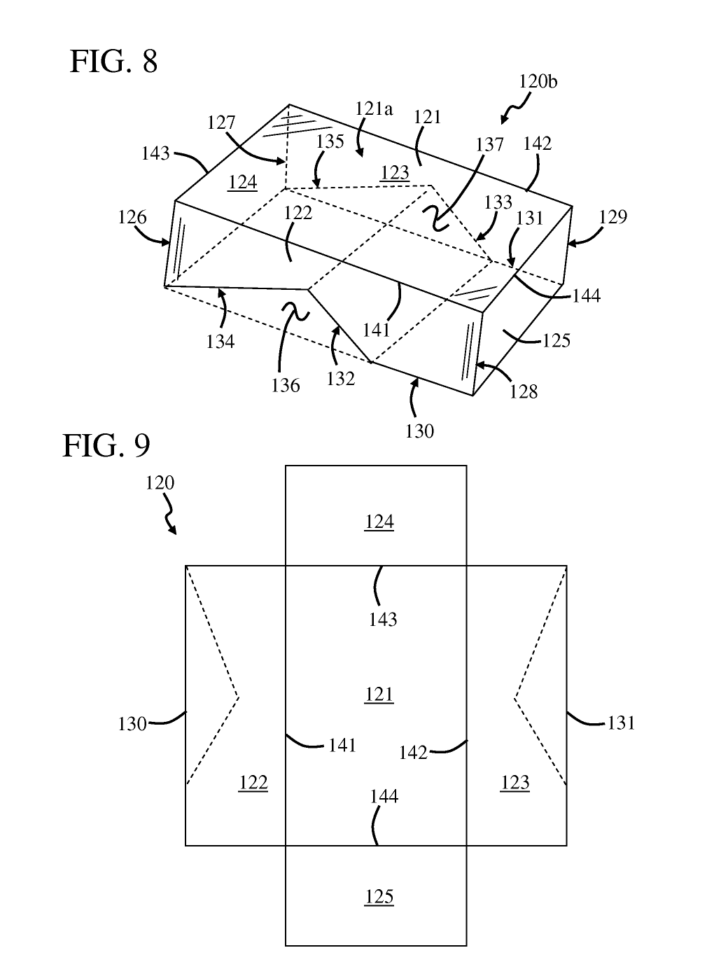

FIGS. 8 and 9 are perspective and top views, respectively, of mounting base 120b in folded and unfolded conditions. In this embodiment, mounting base 120b includes a support wall 121 which has a support surface 121a which engages trolling motor controller 110. In particular, support surface 121a engages foot pedal base 111. In this embodiment, trolling motor controller 110 is fastened to support wall 121 in a repeatably removeable manner. Trolling motor controller 110 can be fastened to support wall 121 in a repeatably removeable manner in many different ways. In this embodiment, fastening devices, such as screws, are used to fasten trolling motor controller 110 to support wall 121 in a repeatably removeable manner. In particular, fastening devices are used to fasten foot pedal base 111 to support wall 121.

In this embodiment, mounting base 120b includes opposed sidewalls 122 and 123 which extend downwardly from support wall 121. Mounting base 120b includes front and back sidewalls 124 and 125 which extend downwardly from support wall 121. Mounting base 120b includes bends 141 and 142 which extend between support wall 121 and sidewalls 122 and 123, respectively. Mounting base 120b includes bends 143 and 144 which extend between support wall 121 and front and back sidewalls 124 and 125, respectively. Bends 141, 142, 143 and 144 extend around an outer periphery of support wall 121 and upper surface 121a.

In this embodiment, mounting base 120b includes downwardly extending welded edges 126 and 127 which extend between front sidewall 124 and sidewalls 122 and 123, respectively. Welded edges 126 and 127 hold front sidewall 124 and sidewalls 122 and 123, respectively, together. Mounting base 120b includes downwardly extending welded edges 128 and 129 which extend between back sidewall 125 and sidewalls 122 and 123, respectively. Welded edges 128 and 129 hold back sidewall 125 and sidewalls 122 and 123, respectively, together. In this way, mounting base 120b includes downwardly extending front and back sidewalls 124 and 125 welded to downwardly extending opposed sidewalls 122 and 123.

In this embodiment, sidewall 122 includes angled edges 132 and 134 which extend from lower edge 130 and towards bend 141. In this way, edges 132 and 134 are angled edges. Further, sidewall 123 includes angled edges 133 and 135 which extend from lower edge 131 and towards bend 142. In this way, edges 133 and 135 are angled edges. Edges 132 and 134 bound a tapered opening 136 and edges 133 and 135 bound a tapered opening 137. Tapered openings 136 and 137 are sized and shaped to receive a portion of boat deck 101. In particular, tapered openings 136 and 137 are sized and shaped to receive a portion of deck transition portion 104b. When tapered openings 136 and 137 receive the portion of deck transition portion 104b, deck transition portion 104b typically engages angled edges 132 and 133. Further, tapered openings 136 and 137 are sized and shaped to receive a portion of upper deck portion 103. When tapered openings 136 and 137 receive the portion of deck transition portion 104b, deck transition portion 104b typically engages angled edges 134 and 135. Hence, tapered openings 136 and 137 are sized and shaped to receive a portion of boat deck 101. In this way, mounting base 120b includes a lower surface that is shaped to extend along upper and lower deck portions and a deck transition portion.

In this embodiment, mounting base 120b is coupled with boat deck 101 in a repeatably removeable manner. Mounting base 120b can be coupled with boat deck 101 in a repeatably moveable manner in many different ways. In this embodiment, mounting base 120b is coupled with boat deck 101 by using mechanical fasteners 138 and 139, as shown in FIGS. 6 and 7. Mechanical fasteners 138 and 139 can be of many different types, such as latches. More information regarding latches can be found in U.S. Pat. No. 4,828,299, the contents of which are incorporated by reference as though fully set forth herein. In this embodiment, mechanical fastener 138 couples front sidewall 124 to upper deck portion 102 and mechanical fastener 139 couples back sidewall 125 to lower deck portion 103. In this way, mounting base 120b is coupled to boat deck 101 in a repeatably removeable manner by using a mechanical fastening device.

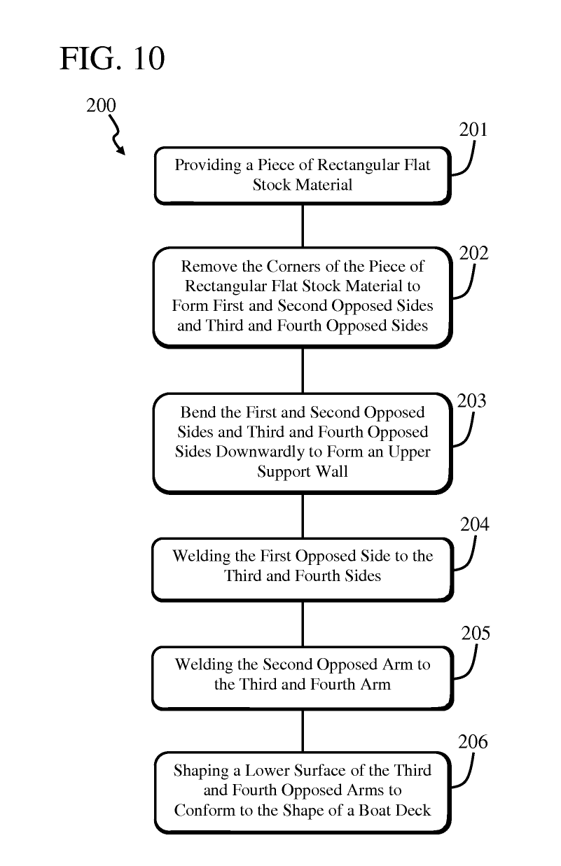

FIG. 10 is a flow diagram of a method 200 of forming a mounting base for a foot operated trolling motor. In this embodiment, method 200 includes a step 201 of providing a piece of rectangular flat stock material and a step 202 of removing the corners of the piece of rectangular flat stock material to form first and second opposed sides and third and fourth opposed sides. Method 200 includes a step 203 of bending the first and second opposed sides and third and fourth opposed sides downwardly to form an upper support wall. Method 200 includes a step 204 of welding the first opposed side to the third and fourth sides and a step 205 of welding the second opposed arm to the third and fourth arms. Method 200 includes a step 206 of shaping a lower surface of the third and fourth opposed arms to conform to the shape of a boat deck. In some embodiments, the step of bending can include forming a bend which extends around the outer periphery of the upper surface.

Method 200 can include many other steps. For example, in some embodiments, method 200 includes a step of attaching a trolling motor foot pedal to the upper surface. Method 200 can include a step of hingedly coupling the first and second arms to the boat deck. In some embodiments, the deck includes upper and lower deck portions and a deck transition portion, wherein the lower surface of the third and fourth opposed arms extends along the upper and lower deck portions and the deck transition portion.

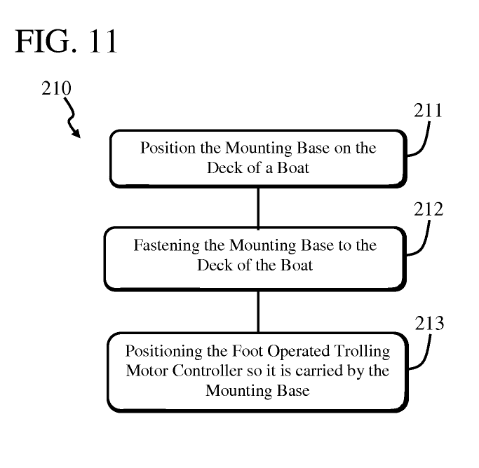

FIG. 11 is a flow diagram of a method 210 of installing a mounting base for a foot operated trolling motor controller. In this embodiment, method 210 includes a step 211 of positioning the mounting base on the deck of a boat and a step 212 of fastening the mounting base to the deck of the boat. Method 210 includes a step 213 of positioning the foot operated trolling motor controller so it is carried by the mounting base. The mounting base can be of many different types, such as those discussed in more detail above.

It should be noted that method 210 can include many other steps. For example, in some embodiments, method 210 includes a step of attaching one or more fasteners to the mounting base and/or the deck of the boat. In some embodiments, method 210 includes a step of positioning the mounting base proximate to a deck transition portion of the boat deck. For example, method 210 can include a step of engaging the mounting base with the deck transition portion of the boat deck. In some embodiments, method 210 includes a step of positioning the mounting base so it extend proximate to upper and lower deck portions, as well as a deck transition portion, of the boat deck.

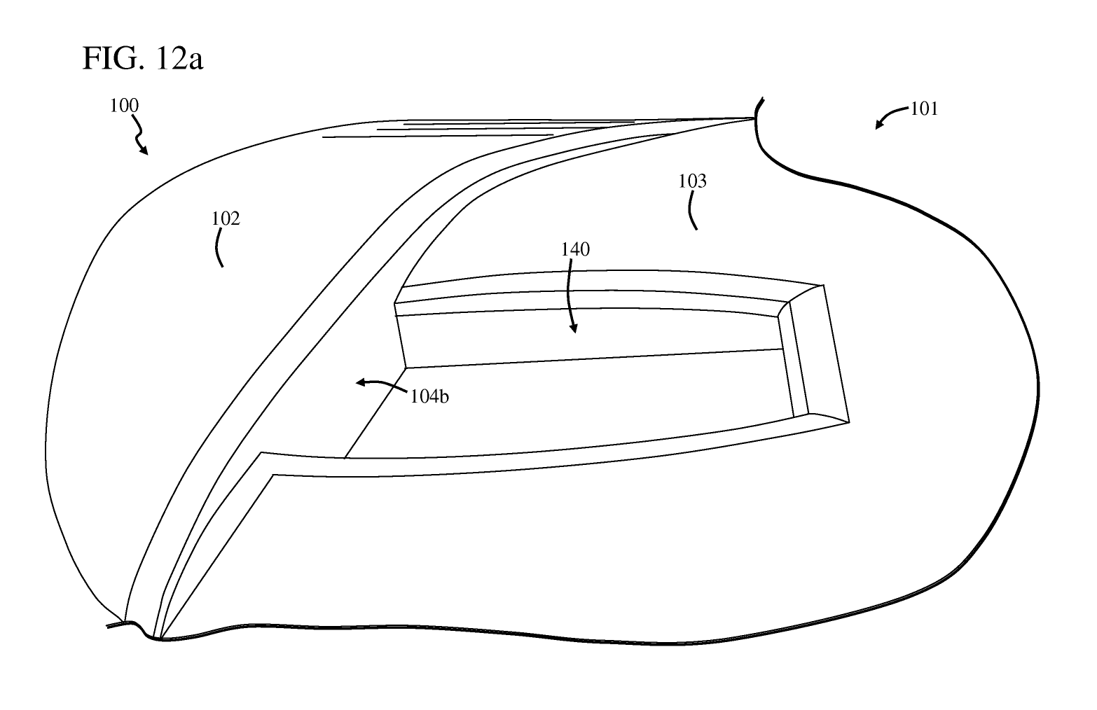

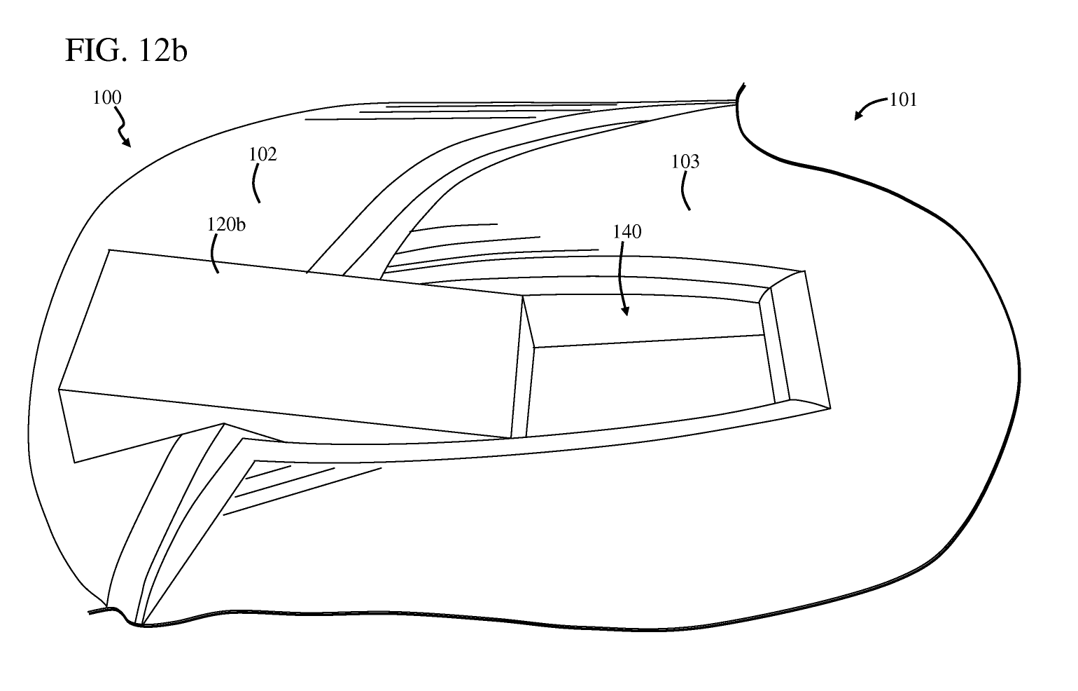

FIGS. 12a and 12b are perspective views of boat 100, which includes upper and lower deck portions 102 and 103, and sloped deck transition portion 104b, as discussed in more detail above. In this embodiment, boat 100 includes a foot operated trolling motor controller channel 140, which extends through lower deck portion 103 and is positioned proximate to sloped deck transition portion 104b. In this embodiment, and as shown in FIG. 12b, mounting base 120b extends through foot operated trolling motor controller channel 140. In particular, mounting base 120b extends through foot operated trolling motor controller channel 140, and over sloped deck transition portion 104b and upper deck portion 102.

The embodiments of the invention described herein are exemplary and numerous modifications, variations and rearrangements can be readily envisioned to achieve substantially equivalent results, all of which are intended to be embraced within the spirit and scope of the invention.

1. Apparatus, comprising:
a boat deck having upper and lower deck portions and a deck transition portion;
a mounting base positioned so it extends proximate to the upper and lower deck portions and the deck transition portion; and
a foot operated trolling motor controller carried by the mounting base.

2. The apparatus of claim 1, wherein the mounting base is attached to the boat deck in a repeatably removeable manner.

3. The apparatus of claim 1, further including a mechanical fastening device which fastens the mounting base to the boat deck.

4. The apparatus of claim 1, wherein the mounting base includes downwardly extending welded edges.

5. The apparatus of claim 1, wherein the upper surface of the mounting base is oriented at a non-zero angle relative to the lower deck portion.

6. The apparatus of claim 1, wherein the mounting base includes downwardly extending front and back sidewalls welded to downwardly extending opposed sidewalls.

7. The apparatus of claim 1, wherein the mounting base includes a bend which extends around the outer periphery of its upper surface.

8. Apparatus, comprising:
a boat deck;
a mounting base with a lower surface shaped to extend along the boat deck, wherein the mounting base includes a downwardly extending welded edge; and
a foot operated trolling motor controller carried by the mounting base.

9. The apparatus of claim 8, wherein the mounting base is fastened to the boat deck in a repeatably removeable manner.

10. The apparatus of claim 8, wherein the boat deck includes upper and lower deck portions.

11. The apparatus of claim 10, wherein the mounting base has a lower surface shaped to extend proximate to the upper and lower deck portions.

12. The apparatus of claim 8, wherein the mounting base includes a tapered opening sized and shaped to receive a portion of the boat deck.

13. The apparatus of claim 8, wherein the mounting base includes a opposed tapered openings sized and shaped to receive a portion of the boat deck.

14. The apparatus of claim 8, wherein the mounting base includes first and second angled edges, the first and second angled edges engaging the upper and lower deck portions, respectively.

15. The apparatus of claim 8, wherein the foot pedal is attached to the mounting base in a repeatably removeable manner.

16. The apparatus of claim 8, wherein the mounting base includes a bend which extends around the outer periphery of its upper surface.

17. A method, comprising:
providing a piece of rectangular flat stock material;
removing the corners of the rectangular flat stock material to form first and second opposed arms and third and fourth opposed arms;
bending the first and second opposed arms and third and fourth opposed arms downwardly to form an upper surface;
welding the first opposed arm to the third and fourth arm;
welding the second opposed arm to the third and fourth arm; and
shaping a lower surface of the third and fourth opposed arms to conform to the shape of a boat deck.

18. The method of claim 17, further including positioning a foot operated trolling motor controller so it is carried by the upper surface.

19. The method of claim 17, wherein the step of bending includes forming a bend which extends around the outer periphery of the upper surface.

20. The method of claim 17, wherein the deck includes upper and lower deck portions and a deck transition portion, wherein the lower edges of the third and fourth opposed arms extend proximate to the upper and lower deck portions and the deck transition portion.
